(19) United States
(12) Patent Application Publication
(10) Pub. No.: US 2007/0130604 A1
(43) Pub. Date: Jun. 7, 2007

(54) Home server having integrated set-top function and controlling method thereof

(76) Inventors: In Tark Han, Daejeon (KR); Jin Soo Han, Daejeon (KR); Youn Kwae Jeong, Daejeon (KR); Kwang Roh Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/607,522

(22) Filed: Dec. 1, 2006

(30) Foreign Application Priority Data
Dec. 7, 2005 (KR) 10-2005-0118880
May 30, 2006 (KR) 10-2006-0049065

(51) Int. Cl. H04N 7/173; H04N 7/16; H04N 7/18

(52) U.S. Cl. 725/131; 725/80; 725/100; 725/139; 725/151

(57) ABSTRACT

A home server having an integrated set-top function and a controlling method thereof are provided. The home server includes a processor unit, a tuner unit, an open cable broadcast receiving unit, and a set-top core unit. The processor unit receives an IPTV broadcast from an access network, includes control S/W for each broadcast type, receives a channel change request from a user, and stores and provides previously-watched channel information. The tuner unit includes a plurality of tuners and receives a MPEG2 TS according to the user's request. The open cable broadcast receiving unit releases a conditional access of the MPEG2 TS and encodes the received MPEG2 TS for copy protection. The set-top core unit receives the MPEG2 TS from the processor unit, the tuner unit and the open cable broadcast receiving unit, selects a channel in response to the control S/W, decodes the selected channel, and outputs video signal.

### RELATED APPLICATION

The present application is based on, and claims priorities from the Korean Patent Application Number 2005-0118880 filed on Dec. 7, 2005 and the Korean Patent Application Number 2006-0049065 filed on May 30, 2006, the disclosure of which is hereby incorporated by reference herein in its entirety.

### BACKGROUND OF THE INVENTION

1. Field of the Invention

The present invention relates to a home server having an integrated set-top function and a controlling method thereof, and more particularly, to a home server having an integrated set-top function that allows a user not only to receives various broadcasting services such as Internet broadcasts, terrestrial broadcasts and cable broadcasts but also to receive high-speed Internet service without purchasing each set-top box for receiving different types of broadcasts.

2. Description of the Related Art

Recently, various types of digital broadcasting services such as terrestrial broadcasts, satellite broadcasts and cable broadcasts have been provided to public. In order to receive these broadcasting services, a set-top box dedicated for each type of the digital broadcasting services is required.

For example, a terrestrial set-top box was introduced for receiving terrestrial broadcasts only, and a satellite set-top box was introduced for receiving a satellite broadcasts only. According to the development of Internet protocol (IP) networks, an IP/terrestrial set-top box, or IP/satellite set-top box were developed to provide an interactive services through an IP network with the terrestrial broadcasts or the satellite broadcasts. Also, an IP set-top box was introduced for receiving an Internet protocol television (IPTV) broadcast.

Meanwhile, a cable set-top box generally provides a function for receiving a TriplePlay service which is an integrated service to provide broadcasting, data and voice services with a cable MODEM.

As described above, in order to receive terrestrial, satellite and cable broadcasts, a user must purchase the IP/terrestrial set-top box, the IP/satellite set-top box and the open cable set-top box, separately. Therefore, such a way of receiving the digital broadcasting services requires high cost to a user. Also, it makes a user inconvenient due to many remote controllers for controlling each set-top box.

In order to allow a user to conveniently receive various digital broadcasting services with the interactive Internet service, the IP/terrestrial set-top box, the IP/satellite set-top box and the open cable set-top box must be developed in a form of hybrid set-top box having an integrated function of receiving digital broadcasting services of IP/terrestrial/open cable. Therefore, there is a demand for an integrated set-top box for selecting one of IP/terrestrial/open cable broadcasting services and receiving the selected broadcasting service.

As the related technology, a digital set-top box was introduced in Korea Patent Application No. 10-2002-0005732, entitled “digital set top box having a function for storing/playing an audio/video signal for the satellite signal, cable signal and ground wave.” The conventional digital set-top box includes a satellite tuner, a cable tuner and a terrestrial tuner. The conventional digital set-top box selects one of the tuners and extracts a MPEG2 TS from the selected tuner. Also, the conventional digital set-top box receives analog audio and video signal from a monitoring camera, and digitalizes the received analog audio and video signals. Then, the conventional digital set-top box selects one of the digitalized signal and the MPEG2 TS of the selected tuner and displays the selected one through a screen so as to allow a user to watch various digital broadcasts. That is, the conventional digital set-top box provides four MPEG2 TSs from three digital broadcasts satellite/cable/terrestrial and digitalized monitoring images, selects one of the four MPEG2 TSs and displays the selected MPEG2 TS.

However, the conventional digital set-top box provides a set-top function to receive digital broadcasting services only. Therefore, there is a demand of a home server having an integrated set-top function for receiving not only various broadcasting services but also high-speed Internet service.

### SUMMARY OF THE INVENTION

Accordingly, the present invention is directed to a home server having an integrated set-top function and a controlling method thereof that substantially obviates one or more problems due to limitations and disadvantages of the related art.

An object of the present invention is to provide a home server having an integrated set-top function and a controlling method thereof for enabling a user to receive various combinations of IP/terrestrial/open cable broadcasts and to control receiving of broadcasts with single remote controller.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a home server having an integrated set-top function includes: a processor unit for receiving an IPTV (Internet protocol television) broadcast from an access network, including control software (S/W) for each broadcast type, receiving a request to change a channel or a broadcast type from a user and performing related processes, and storing previously-watched channel information of each broadcast type and providing the stored channel information to a user when the home server is driven; a tuner unit for including a plurality of tuners and receiving a predetermined MPEG2 TS (moving picture experts group 2 transport stream) according to the user's request; an open cable broadcast receiving unit for releasing a conditional access of the received MPEG2 TS from the tuner unit and encoding the received MPEG2 TS for copy protection; and a set-top core unit for receiving the MPEG2 TS from the processor unit, the tuner unit and the open cable broadcast receiving unit, selecting a channel in response to the control of the control S/W, decoding the selected channel, and outputting video signal.

According to an aspect of the present invention, there is provided a method for controlling a home server having an integrated set-top function including the steps of: a) obtaining previously-watched channel information of each broadcast type from a CPU by driving channel S/W of each broadcast type; b) receiving MPEG2 TS of previously-watched channel of each broadcast type using the obtained channel information; and c) selecting a latest-watched channel among the corresponding received channels of each broadcast type, and decoding the selected channel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a home server according to an embodiment of the present invention;

FIG. 2 is a block diagram illustrating a processor unit 110 in a home server according to an embodiment of the present invention;

FIG. 3 is a block diagram illustrating tuner units in a home server according to exemplary embodiments of the present invention;

FIG. 4 is a block diagram illustrating a set-top core unit in a home server according to an embodiment of the present invention;

FIG. 5 is a block diagram illustrating an open cable broadcast receiving unit in a home server according to an embodiment of the present invention; and

FIG. 6 is a flowchart describing watching of a desired channel by selecting one of broadcastings in a home server according to an embodiment of the present invention.

### DETAILED DESCRIPTION OF THE INVENTION

Reference will now be made in detail to the preferred embodiments of the present invention, examples of which are illustrated in the accompanying drawings.

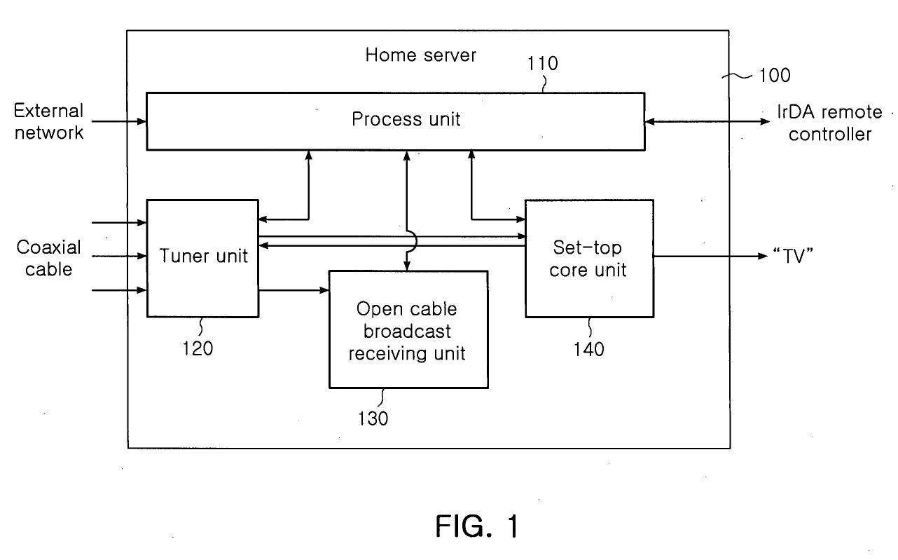

FIG. 1 is a block diagram illustrating a home server according to an embodiment of the present invention.

Referring to FIG. 1, the home server according to the present embodiment includes a processor unit 110, a tuner unit 120, an open cable broadcast receiving unit 130 and a set-top core unit 140. The processor unit 110 receives Internet protocol television (IPTV) broadcast from an access network and includes control software (s/W) of each broadcast type. Also, the processor unit 110 receives requests to change a channel or a broadcast type from a user and performs related processes so as to change the channel and the broadcast type according to the user's request. Furthermore, the processor unit 110 stores previously-watched channel information of each broadcast type and provides the stored channel information to user when a home server is driven. The tuner unit 120 includes a plurality of tuners and receives a predetermined MPEG2 TS according to the user's request. The open cable broadcast receiving unit 130 releases the conditional access of the received MPEG2 TS from the tuner unit 120 and encodes the received MPEG2 TS for copy protection. The set-top core unit 140 receives the MPEG2 TS from the processor unit 110, the tuner unit 120 and the open cable broadcast receiving unit 130, selects a channel in response to the control of the control S/W, and decodes the selected channel.

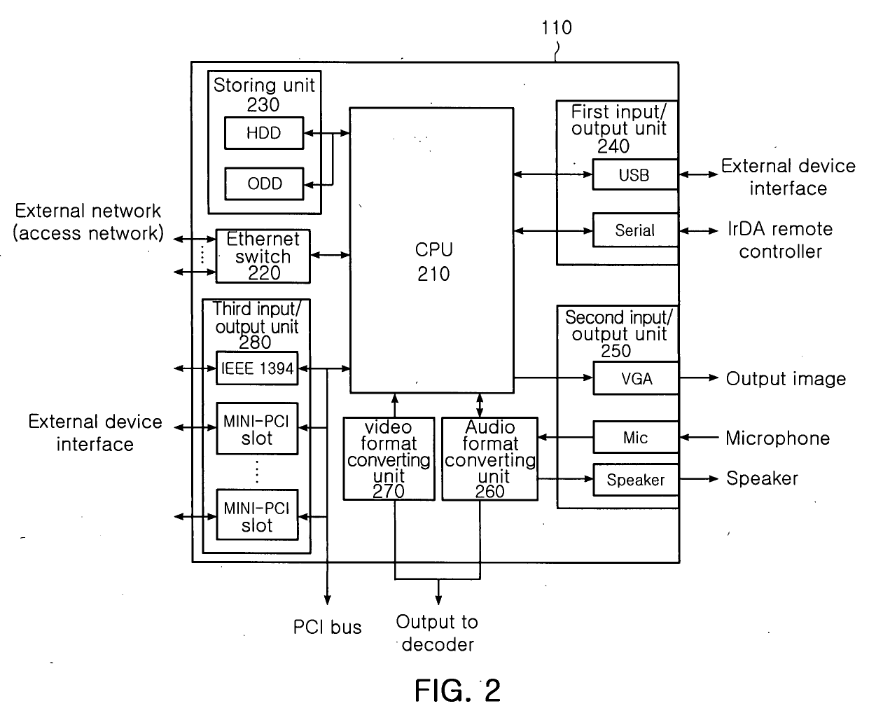

FIG. 2 is a block diagram illustrating a processor unit 110 in a home server according to an embodiment of the present invention.

Referring to FIG. 2, the processor unit 110 of the home server includes an Ethernet switch 220, a central processing unit (CPU) 210, a first input/output unit 240, a second input/output unit 250, a third input/output unit 280, a video format converting unit 270, an audio format converting unit 260, and a storing unit 230. The Ethernet switch 220 include a plurality of Ethernet ports for receiving data traffics related to an IPTV broadcast from an external access network and transferring the received data to the CPU 210. The CPU 210 outputs a MPEG2 TS received from the Ethernet switch 220 to the video and audio format converting units 260 and 270 and includes control-software (S/W) for each broadcast type. The CPU 210 receives a request to change a channel or a broadcast type from a user and performs related processes for changing the channel or the broadcast type according to the user's request. Also, the CPU 210 stores previously-watched channel information of broadcast types and provides the stored channel information to the control S/W of corresponding broadcasting channel when the home server 100 is driven. The first input/output unit 240 includes a USB interface and a serial interface. The first input/output unit 240 communicates with an external device through the USB interface and the serial interface for inputting data to the CPU 210 and outputting data from the CPU 210. The second input/output unit 250 includes a video graphic array (VGA) output unit which is a graphic card for outputting video data outputted from the CPU 210, a microphone input unit for inputting audio data to the audio format converting unit 260 and a speaker output unit for outputting audio data outputted from the audio format converting unit 260. The third input/output unit 280 communicates with an external device through a plurality of mini PCI slots and corresponding ports thereof and communicates with internal elements of the home server through the PCI bus for transferring data to the CPU 210. The video format converting unit 270 converts video data outputted from the CPU 210 into a predetermined format and outputs the converted video data to the set-top core unit 140 so as to display the converted video data through a TV. The audio format converting unit 260 receives audio data from the microphone or the CPU 210, converts the received data in a predetermined format so as to output the audio data through the speaker. The storing unit 230 includes a hard disk drive (HDD) for storing programs and data, and an optical disk drive (ODD) for storing or reading data to/from a DVD-ROM.

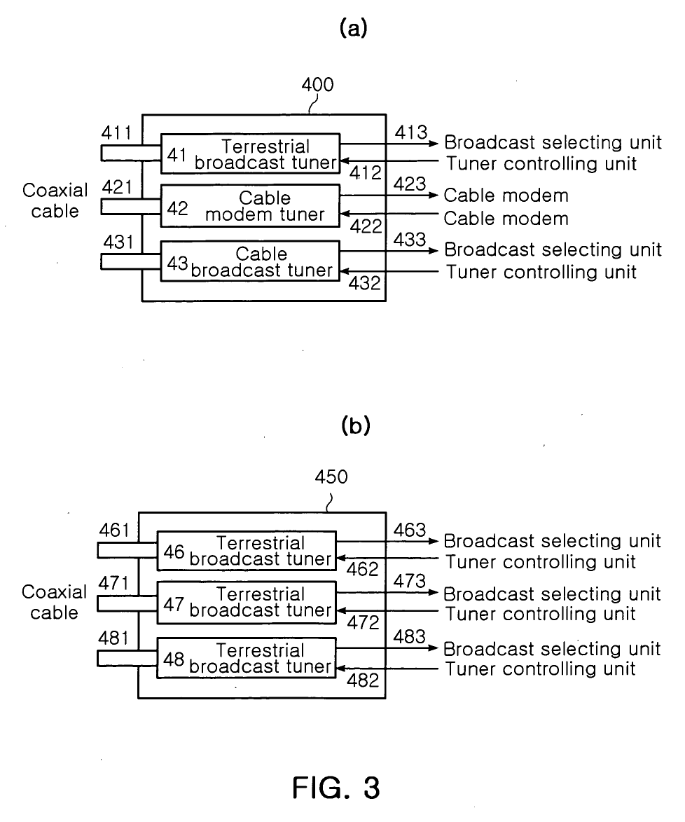

FIG. 3 is a block diagram illustrating tuner units in a home server according to exemplary embodiments of the present invention. The diagram (a) illustrates a tuner unit 400 according to a first embodiment of the present invention which is formed of the combination of a terrestrial broadcasting tuner 41, a cable MODEM tuner 42 and a cable broadcast tuner 43. The diagram (b) shows a tuner unit 450 according to a second embodiment of the present invention which is formed of the combination of three terrestrial tuners 46, 47, and 48.

Referring to the diagram (a) of FIG. 3, the tuner unit 400 according to the first embodiment includes a terrestrial broadcasting tuner 41 for selecting a requested channel among input terrestrial broadcasting signals and outputting the data of the selected channel, a cable MODEM tuner 42 for transforming RF band signals inputted from a coaxial cable 421 to baseband signals and outputting the baseband signal, and a cable broadcast tuner 43 for receiving a cable broadcasting signal from a coaxial cable 431, selecting a requested channel and outputting the data of the selected channel.

Referring to the diagram (b) of FIG. 3, the tuner unit 450 is composed of a combination of three terrestrial broadcasting tuners 46, 47 and 48.

The tuner unit 450 includes three terrestrial tuners 46, 47 and 48 for receiving broadcasting from each corresponding coaxial cable.

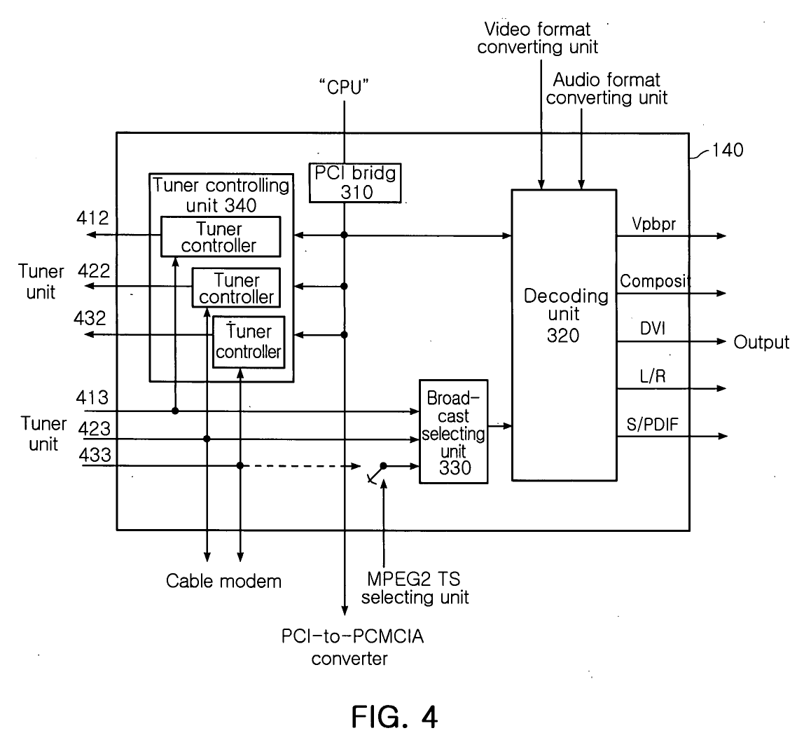

FIG. 4 is a block diagram illustrating a set-top core unit in a home server according to an embodiment of the present invention.

Referring to FIG. 4, the set-top core unit 140 according to the present embodiment includes a PCI bridge 310, a decoding unit 320, a broadcast selecting unit 330, and a tuner controlling unit 340. The decoding unit 320 receives audio and video signals of Internet broadcast from the video and audio converting units 260 and 270 in the processor unit 110 through the PCI bus and also receives MPEG2 TS from the tuner unit 120. Then, the decoding unit 320 decodes the received video and audio signals and MEPG2 TS so as to display them through a high definition television (HDTV). The PCI bridge 310 is provided to accommodate a plurality of PCI slots at the PCI bus. The tuner controlling unit 340 control operations of the tuners included in the tuner unit 120. The broadcast selecting unit 330 selects one of MPEG2 TSs inputted from the tuner unit 120 and transfers the selected MPEG TS to the decoding unit 320.

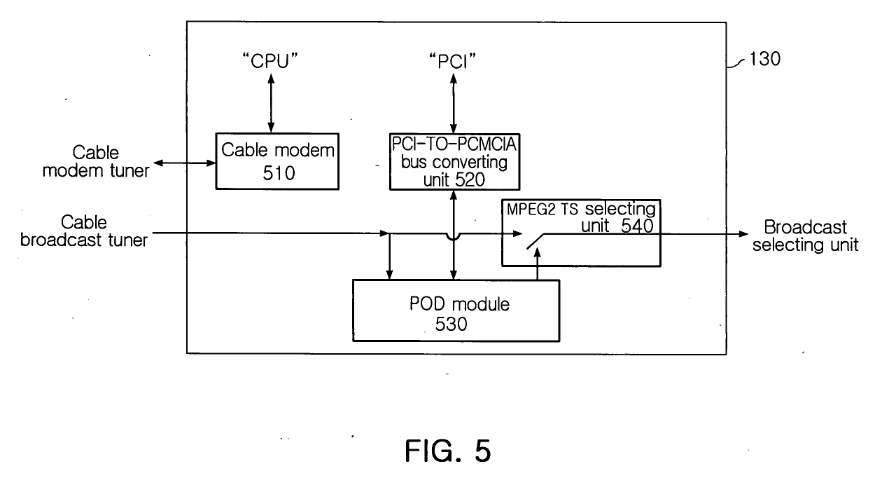

FIG. 5 is a block diagram illustrating an open cable broadcast receiving unit in a home server according to an embodiment of the present invention.

Referring to FIG. 5, the open cable broadcast receiving unit 130 according to the present embodiment includes a cable MODEM 510, a PCI-to-PCMCIA bus converting unit 520, a POD module 530, and a MPEG2 TS selecting unit 540. The cable MODEM 510 demodulates a baseband signal outputted from the cable MODEM 42 of the tuner unit 120, modulates data to transmit to the CPU 210 into a baseband signal, and transfers the demodulated signal and the modulated signal to the cable MODEM tuner 42. The cable MODEM 510 is connected to the Ethernet switch 111 of the processor unit 110 to modulate signals. The PCI-to-PCMCIA bus converting unit 520 is connected to the CPU 210 of the processor unit 110 through a PCI bus, and relays communication to the POD module 530. The POD module 530 decodes the CAS-encoded MPEG2 TS received from the cable broadcast tuner 43 and outputs the decoded MPEG2 TS to the MPEG2 TS selecting unit 540. The MPEG2 TS selecting unit 540 selects one of the MPEG2 TS received from the POD module 530 and MPEG2 TS received from the cable broadcast tuner 43, and outputs the selected MPEG2 TS to the broadcast selecting unit 330 of the set-top core unit 140.

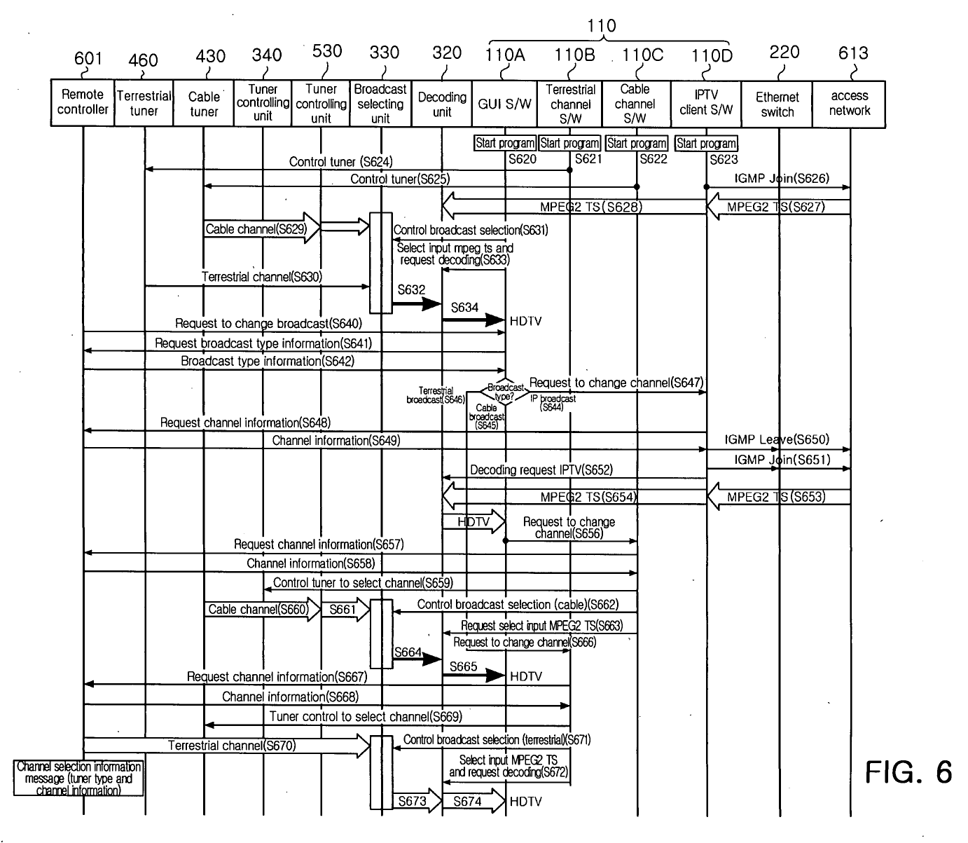

FIG. 6 is a flowchart describing watching of a desired channel by selecting one of broadcastings in a home server according to an embodiment of the present invention.

Referring to FIG. 6, when the home server 100 begins, the CPU 210 of the processor unit 110 drives a graphic user interface (GUI) S/W 110A at step S620, and receives data of a corresponding channel by controlling a corresponding tuner using the stored channel information stored in the processor unit 110 of the home server 100.

For example, in case of the terrestrial broadcast, when a terrestrial channel S/W 110B is driven at step S621, the data of a corresponding channel is received at step S630 by controlling the terrestrial tuner 460 using previously-watched terrestrial channel information stored in the processor unit 110 at step S624.

In case of the cable broadcast, when a cable channel S/W 110C begins at step S622, the data of a corresponding channel is received at step S625 by controlling the cable change broadcasting tuner 430 using the remained previously-watched cable channel information. Herein, since the channel is encoded, the POD module 530 of the open cable broadcast receiving unit receives a decoding key from the processor unit 110 connected to the PCI bus through the PCI-to-PCMCIA bus converting unit 520, and decodes a CAS code with the received decoding key. Also, the POD module 530 encodes the channel for copy protection and transmits the channel to the broadcast selecting unit 330 of the set-top core unit 140.

Also, if an IPTV client S/W 110D begins at step S623, an Internet group management protocol (IGMP) Join message is transferred to an access network through the Ethernet switch 220 at step S626. Then, a MPEG2 TS, which is transferred with an IP multicast packet, is received from an IPTV server as a response of the IGMP Join message at step S627. The MPEG2 TS is extracted and transferred to the decoding unit 320 of the set-top core unit 140 at step S628. The broadcast selecting unit 330 receives a broadcasting selection signal from the GUI S/W 110A of the processor unit 110 at step S631 in order to inform previously-watched broadcasting channel information among the terrestrial channel and the cable channel(S629, S630). Then, a MPEG2 TS of corresponding channel is selected from the broadcasted MPEG2 TSs at step S632.

Also, the GUI S/W 110A transmits an input MPEG2 TS selection and decoding signal to the decoding unit 320 at step S633 to enable the decoding unit 320 to select the previously-watched broadcasting channel. Then, the decoding unit 320 decodes the MPEG2 TS of the latest-watched broadcasting channel and outputs the decoded MPEG2 TS.

As described above, when the home server 100 begins, the broadcast of the latest-selected channel is transferred and displayed at a TV. Then, a user is allowed to change the channel as follows.

At first, a user transmits a broadcast changing request signal to the GUI S/W 110A when the user wants to change a broadcast to watch and a channel thereof through a remote controller 601(S640). Herein, the remote controller 601 communicates with the first input/output unit 240 of the processor unit 110. The first input/output unit 240 drives the GUI S/W 110A by being connected to the CPU 210. The GUI S/W 110A requests a desired broadcast type to a user at step S641, and a user selects a desired broadcast type as the response of the request and transfers the selection to the GUI S/W 110A through the remote controller 601 at step S642. Herein, if the desired broadcast type of the user is an IP broadcast at step S644, a channel change request signal is transmitted to the IPTV client S/W 110D at step S647. The IPTV client S/W 110D request channel information to a user at step S648. When the user inputs the channel information using a remote controller 601 as the response of the request of the channel information at step S649, the IPTV client S/W 110D transmits an IGMP Leave message to a corresponding IPTV server through an access network 613 so as to interrupt a currently transmitting channel at step S650. Then, the IPTV client S/W 110D transmits the IGMP Join message to the IPTV server through an access network 613 to the IPTV server at step S651.

The IPTV client S/W 110D requests the decoding unit 320 to decode the IPTV channel at step S652. At the same time, the IPTV client S/W 110D extracts a MPEG2 TS and transfers the extracted MPEG2 TS to the decoding unit 320 at step S654 when the MPEG2 TS of the IPTV channel is received with the IP multicast packet at step S653. Then, the decoding unit 320 decodes the inputted IPTV MPEG2 TS.

If the broadcast type requested by the user is a cable broadcast at step S645, the GUI S/W 110A transmits a channel change request signal to. the cable channel S/W 110C at step S656. The cable channel S/W 110C controls the cable tuner 430 through the tuner controlling unit 340 at step S659 to transmit the MPEG2 TS received from the user requested channel to the POD module 530 at step S660. The POD module 530 releases the CAS code of the MPEG2 TS, locks a copy protection code on the MPEG2 TS, and transmits the MPEG2 TS to the broadcast selecting unit 330. Herein, The cable channel S/W 110C transmits a message to enable the broadcast selecting unit 330 to select a cable broadcasting at step S662. Also, the cable channel S/W 110C transmits a message to enable the decoding unit 320 to decode the cable broadcasting channel at step S663.

If the broadcast type requested by the user is a terrestrial broadcast at step S646, the GUI S/W 110A transmits a channel change request to a terrestrial channel S/W 110B at step S666. The terrestrial channel S/W 110B request channel information from a user at step S667. The user transfers the channel information as the response of the request at step S668. The terrestrial channel S/W 110B transmits a MPEG2 TS received from the user requested channel to the broadcasting selection unit 330 by controlling the terrestrial tuner 460 through the tuner controlling unit 340 at step S669. Herein, the terrestrial channel S/W 110B transmits a message to enable the broadcasting selection unit 330 to select the terrestrial broadcasting at step S671. Also, the terrestrial channel S/W 110B transmits a message to enable the decoding unit 320 to decode the terrestrial broadcasting channel at step S672.

As described above, the home server having the integrated set-top function according to the present invention performs multiple set-top functions for receiving not only various digital broadcasts but also high-speed Internet service. Since a user does not need to purchase each set-top box for different broadcasting services, the cost thereof is reduced. Also, a space for the set-top boxes can be saved because various set-top functions are included in one device.

Since the home server for receiving various broadcast signals according to the present invention has a single set-top configuration, a user is allowed to select a channel with single remote controller.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A home server having an integrated set-top function comprising:
a processor unit for receiving an IPTV (Internet protocol television) broadcast from an access network, including control software (S/W) for each broadcast type, receiving a request to change a channel or a broadcast type from a user and performing related processes, and storing previously-watched channel information of each broadcast type and providing the stored channel information to a user when the home server is driven;
a tuner unit for including a plurality of tuners and receiving a predetermined MPEG2 TS (moving picture experts group 2 transport stream) according to the user's request;
an open cable broadcast receiving unit for releasing a conditional access of the received MPEG2 TS from the tuner unit and encoding the received MPEG2 TS for copy protection; and
a set-top core unit for receiving the MPEG2 TS from the processor unit, the tuner unit and the open cable broadcast receiving unit, selecting a channel in response to the control of the control S/W, decoding the selected channel, and outputting video signal.

2. The home server of claim 1, wherein the processor unit includes:
a CPU (central processing unit) for providing an interface for controlling channels of each broadcast type to a user, controlling transceiving of an IPTV broadcast according to a request of a user received through the interface, including channel S/W (software) of each broadcast type, and controlling an operation of a tuner unit;
an Ethernet switch including a plurality of ports for transferring an IPTV broadcast related message to an access network by connecting the CPU and the access network, and transferring traffic related to an IP broadcast transferred from the access network;
a first input/output unit including a USB (universal serial bus) interface and a serial interface, connected to peripheral devices, reading data from a corresponding peripheral device, transferring the read data to the CPU, and transmitting predetermined data in response to the control of the CPU;
a second input/output unit for transmitting data to the CPU by communicating with internal elements in the home server through a PCI bus and communicating with an external device through a corresponding port and a plurality of mini PCI slots;
a third input/output unit including a VGA output unit, a microphone input unit and a speaker output unit for inputting and outputting video and audio inputted from and outputted to the CPU;
an audio CODEC for converting audio data inputted from the CPU and the third input/output unit into a predetermined format; and
a video output format converting unit for converting video data outputted from the CPU into a predetermined format.

3. The home server of claim 2, further comprising a remote controller connected to the first input/output unit of the processor unit for transferring a channel selection signal for each broadcast type from a user to a CPU.

4. The home server of claim 1, wherein the set-top core unit includes:
a tuner controlling unit for controlling operations of the tuner unit in response to the control of a CPU in the processor unit;
a broadcast selecting unit for selecting a MPEG2 TS requested from the CPU among MPEG2 TSs transferred from the tuner unit; and
a decoder for decoding the selected MPEG2 TS from the broadcast selecting unit, decoding video and audio signal inputted from the CPU of the processor unit, and outputting the decoded MPEG2 TS, audio and video signal.

5. The home server of claim 1, wherein the tuner unit includes:
a terrestrial broadcasting tuner for receiving a terrestrial MPEG2 TS from a coaxial cable, receiving a request to select a channel from the tuner controlling unit, selecting and receiving the requested channel;
a cable MODEM tuner for transforming RF band signals inputted from a coaxial cable to baseband signals and transferring the baseband signals to the open cable broadcast receiving unit; and
a cable broadcast tuner for receiving a MPEG2 TS from a coaxial cable, receiving a request to select a channel from the tuner controlling unit, selecting and receiving the requested channel.

6. The home server of claim 1, wherein the tuner unit includes a plurality of terrestrial broadcast tuners for receiving a terrestrial MPEG TS from a coaxial cable, receiving a request to select a channel from the tuner controlling unit, and selecting the requested channel.

7. The home server of claim 1, wherein the open cable broadcast receiving unit includes:
a cable MODEM for modulating a baseband signal received from the cable MODEM tuner and transferring the modulated baseband signal to the cable MODEM tuner, and performing a demodulation so as to process as an Ethernet frame of the processor unit;
a PCI-to-PCMCIA converter connected to the processor unit through a PCI for communicating with a POD module; and
a POD module for releasing a conditional access of the MPEG2 TS received from the cable broadcast tuner, performing an encoding for copy protection and communicating with the CPU through the PCI-to-PCMCIA converter.

8. A method for controlling a home server having an integrated set-top function comprising the steps of:
a) obtaining previously-watched channel information of each broadcast type from a CPU by driving channel S/W of each broadcast type;
b) receiving MPEG2 TS of previously-watched channel of each broadcast type using the obtained channel information; and
c) selecting a latest-watched channel among the corresponding received channels of each broadcast type, and decoding the selected channel.

9. The method of claim 8, further comprising the steps of:
d) receiving a channel change request signal from a user;
e) requesting a broadcast type to a user and receiving a requested broadcast type from a user;
f) transmitting the channel change request signal to a broadcast channel S/W corresponding to the received requested broadcast type;
g) at the channel S/W of each broadcast channel, requesting channel information to change to a user;
h) receiving channel information from a user;
i) selecting a broadcast channel requested by a user according to the received channel information, and transferring the selected broadcast channel to a broadcast selecting unit;
j) transmitting a control message to enable the broadcast selecting unit to select a corresponding broadcast channel; and
k) decoding the MPEG2 TS selected by the broadcast selecting unit.

10. The method of claim 8, wherein the step b) includes the steps of:
at an IP client S/W, transmitting an IGMP (Internet group management protocol) Join message to a user requested channel of an access network through an Ethernet switch; and
receiving a MPEG2 TS which is transmitted with being included in an IP multicast packet from the access network.

11. The method of claim 8, wherein the step b) includes the step of transferring a decoded MPEG2 TS from a cable broadcast tuner to a POD module for releasing a conditional access thereof, and at the POD module, encoding the MPEG2 TS for copy protection and transferring the MPEG2 TS to a broadcast selecting unit.

12. The method of claim 8, wherein the step b) further includes the step of receiving a MPEG2 TS received from a corresponding channel of a terrestrial broadcast from the terrestrial tuner.

13. The method of claim 9, wherein the step f) includes the steps of:
at an IPTV client, interrupting a previous channel by transmitting an IGMP Leave message to an access network; and
transmitting an IGMP Join message to a requested channel.
